(19) United States
(12) Patent Application Publication
(10) Pub. No.: US 2006/0080069 A1
(43) Pub. Date: Apr. 13, 2006

(54) System for analyzing fastener loads

(76) Inventor: William Fujimoto, University City, MO (US)

Correspondence Address: ROBERT E. CANNUSCIO;DRINKER BIDDLE & REATH LLP, One Logan Square, 18th & Cherry Streets, Philadelphia, PA, 19103-6996, US

(21) Appl. No.: 10/963,909

(22) Filed: Oct. 12, 2004

(51) Int. Cl. G06F 17/10

(52) U.S. Cl. 703/2

(57) ABSTRACT

A system is disclosed for analyzing a mechanically fastened lap shear joint and for determining the stress state in the fastener and in holes surrounding the fastener. Each fastener is modeled as a line element in a computer-based finite element model. A stiffness matrix representative of the fastener is incorporated into the system stiffness matrix, allowing nodal displacements and forces of the line element to be determined. Coefficients of the stiffness matrix are calculated based on a model of the fastener as a beam supported by elastic supports. The calculation procedure includes calculating distributed forces resulting from unit displacements imposed separately on the line element nodes, while the other line element nodes are assumed fixed. Concentrated forces equivalent to the distributed forces are calculated by work-averaging the continuous forces. The line element stiffness matrix coefficients are calculated, allowing the stress state in the holes and fastener to be determined.

### FIELD OF THE INVENTION

The invention relates generally to the field of stress analysis, and more particularly to a finite element analysis tool for multi-layered joints connected by one or several fastener(s).

### BACKGROUND OF THE INVENTION

Multi-layered joints connected by fasteners, such as rivets or nuts and bolts, are commonly used in structural design, and are particularly common in aircraft design. With reference to FIG. 1, a typical overlapping or lap joint 10 comprises first, second, and third components or layers, 20, 30, and 40, respectively, connected by a fastener 50. The joint 10 is not limited to three layers, but may include two or more layers. The fastener 50 comprises a shank portion 52, having a first end 54 and a second end 56. The components 20, 30, and 40 may be subjected to generalized forces F (illustrated as axial tensile forces, but the generalized forces F could be a force or moment in any direction). The generalized forces F act to deform the fastener 50 from an un-deformed state 58 into a deformed state 60 (shown greatly exaggerated in dashed lines in FIG. 1).

Accurate stress analysis of such joints is often critical, particularly in aircraft design where, to minimize weight, components are often designed to operate at high levels of stress. Various techniques are known in the art for performing stress analysis of overlapping, multi-layered joints 10 connected by a fastener 50. In these approaches, the presence of the hole itself is ignored and the layers being connected by the fasteners are idealized as either beam elements or plate/shell elements of zero thickness (i.e., a wireframe model approach). The beam or plate elements have zero apparent thickness, but the bending and extensional stiffness properties of the elements are based on the actual thicknesses. In a wireframe model, each layer is represented by an assemblage of beam (or shell/plate) elements at the mid-thickness of the layer, and each layer can be interconnected by suitable line elements representing the fasteners. An advantage to the use of beam (or shell/plate) elements for the layers is that only a single nodal point is required to connect the layer to the fastener. In addition, conventional two node bar elements may be used without modification to represent the fastener. The wireframe model approach is the method typically used in the stress analysis of lap joints 10.

Various particular approaches can be used for creating wireframe models of joints. With reference to FIG. 2, a simple approach is to develop a wireframe model 70 to model the connection between each layer with beam elements 72 which have the same cross section geometry as the fastener shank 52 and which extend between nodal points 74. This approach leads to an incompatibility between the displaced shape of the fastener and the displaced shape of the beam (or plate/shell) wireframe elements connected to the fastener, since the beam (or plate/shell) elements assume “point” translations and rotations at the node 74. Because the implied fastener deformation is physically incompatible with the deformation of the elements representing the layers, this approach can only serve as a first order approximation. The primary advantage to the approach 70 is that the holes are not explicitly included in the finite element mesh for the joint, but are represented by single nodes 74.

While such wireframe models 70 are less labor intensive to construct than models with the holes explicitly included in the mesh, the simple line model of the fastener is only a rough approximation for joints with more than two layers, as it fails to account for cross coupling effects between non-adjacent components. As a result, the assembly of fastener elements does not have the same mechanical response as an actual fastener if the joint has more than two layers and, accordingly, there is no assurance that the layer-by-layer bearing loads determined using the line elements correspond to the actual layer-by-layer loads acting on the fastener. Consequently, this approach leads to inaccuracies in determining the load transferred between each layer component and the fastener, as well in synthesizing the stress field surrounding the fastener.

In more recent years, the development of solid finite elements, in which the structure can be discretized into volumetric rather than wireframe elements, has permitted the development of more refined approaches for modeling mechanically fastened joints. In the approaches utilizing volumetric elements, fasteners are idealized as an assemblage of these elements, with the geometry of the assemblage having the same geometry as the actual fastener. In the models, the hole must be explicitly included in the mesh in order to determine the stress field surrounding the hole. For example, with reference to FIG. 3, such joints 10 are analyzed by a detailed volumetric finite element model 80. In order to account for the discontinuity associated with holes in the layers 20, 30 and 40, and in view of the relatively high stress gradients occurring near the bore of such holes, it is generally necessary to provide a relatively dense mesh of first, second and third component nodes 22, 32 and 42, in the region of the fastener holes. Further, it is necessary to model the fastener 50 in a relatively detailed manner, providing a similarly dense mesh of fastener nodes 62. Such a model 80 is further complicated by the need to model the generally non-linear bearing contact between the fastener shank 52 and the hole wall. This requires creating a fine mesh of the hole which surrounds the shank at each layer of the joint. In short, stress analysis of multilayered joints 10 using detailed volumetric finite element models is labor intensive and costly. For a structure containing many such interconnected overlapping joints 10, the cost of individually modeling each joint 10 can easily become prohibitive.

Virtual fastener technology has recently been developed based on a modeling technique developed by W. T. Fujimoto. A Fujimoto model 110 (see FIGS. 5B and 5C, discussed below) is described in “Modeling Multi-Stage Failure Mechanisms in Joints with Cold-Worked Holes”, Proceeding of 2002 ASIP Conference, Savannah, Ga. (2002) and “Analytic Testing of Joints with Cold-worked Holes”, Proceedings of 2001 Aging Aircraft Conference, Orlando, Fla. (2001), and utilizes a beam-on-elastic foundation model 90 of the fastener 50 developed by W. Barrois, “Stresses and Displacements Due to Load Transfer by Fasteners in Structural Assemblies”, Engineering Fracture Mechanics, Vol. 10, pp. 115-176 (1975).

With reference to FIGS. 4A-4D, the virtual fastener approach described in the above-mentioned papers allows the stress field surrounding each hole to be synthesized from a wireframe model without the hole explicitly meshed. The beam-on-elastic foundation model 90 (see FIG. 4B) of a joint 10 having fastener 50 joining a first layer 20 and a second layer 30 (see FIG. 4A) is used to determine the bypass stresses and the bearing stresses in the vicinity of a hole via a “collapsed wireframe” model 100 (see FIG. 4D) of the multi-layer lap joint 10. In this “collapsed wireframe” approach 100, the layers of a wireframe model 70 (see FIG. 4C) of the joint 10 are collapsed into a single layer 102, reducing the dimensionality of the joint 10 to one involving only co-planar translational forces, eliminating overturning moments on the virtual fastener element. Because the virtual fastener element is represented by an assemblage of springs, it can be easily added to existing general purpose finite element programs. Once the bypass stress and the bearing stresses in the vicinity of the fastener have been found from the solution of the finite element model of the joint, the stress field surrounding the hole can be synthesized by multiplying available two-dimensional membrane solutions (an example of available solutions are those in S. Timoshenko, Theory of Elasticity, McGraw-Hill, 3^{rd} ed., 1951, page 52 for an open hole in a strip loaded in uniaxial tension and in P. S. Theocaris, “The Stress Distribution in a Strip Loaded in Tension By Means of a Central Pin”, Transactions of the ASME, Vol. 78, Applied Mechanics Section, page 482 (1956) for a pin-loaded hole in a strip by the bypass and bearing stresses, respectively. The beam-on-elastic foundation model 90 and associated calculation techniques are limited to two layer lap shear joints, although it can be extended to three-layer double shear joints by symmetry. However, it is incapable of dealing with three-layer non-symmetric joints, or with joints with more than three layers.

Referring now to FIGS. 5A-5C, the Fujimoto model 110 used for extending the Barrois beam-on-elastic foundation approach 90 to more than two layers is illustrated. The Fujimoto model 110 analyzes the fastener 50 as a set of springs 112. While the springs 112 are shown, for illustrative purposes, as having connecting nodes 114 which are not aligned in the same horizontal plane, as required to prevent overturning moments, it is to be understood that in implementing this approach in a computer program, each of the layers in the stack-up must be collapsed into a single layer; hence, the connecting nodes 114 for the springs 112 lie in the same plane. In the Fujimoto approach 110, each fastener 50 is modeled as a system of series and parallel springs 112a and 112b whose properties are determined from a two layer beam-on-elastic foundation model 90 of the fastener 50. The stiffness of direct or series springs 112a which connect two contiguous layers are obtained directly from a Barrois model 90 of a two layer fastener, while the stiffness of the parallel springs 112b which couple layers separated by other layers is approximated by modifying the Barrois solution to include a gap between the layers (the thickness of the gap being equal to the separation between the layers). The use of series and parallel springs 112a, 112b allows the beam-on-elastic foundation model 90 for two layer joints 10 to be extended to joints 10 with more than two layers in single shear. The series spring 112a represents the direct coupling between layers, while the parallel springs 112b represent cross coupling between layers which are separated by one or more layers between. FIG. 5C illustrates a Fujimoto model 110 including a plurality of fasteners 50.

While the Fujimoto model 110 is an improvement over prior modeling techniques, it is limited inasmuch as it is based on the “collapsed wireframe” model 100 approach which idealizes the fastener as a series of shear springs, thus leading to a non-equilibrating system of forces on the fastener. To use the approach with a multi-layer lap joint, the layers would have to be collapsed into a single plane. Otherwise, the fastener would be subjected to overturning moments and would not be in equilibrium. As such, the Fujimoto model 110 shown in FIGS. 5A-5C cannot be used with a general finite element program with each layer represented by an assemblage of beam (or plate/shell) elements passing through the layer mid-thickness, since such a program requires that each element satisfy force and moment equilibrium and be displacement compatible. Furthermore, the failure of the “collapsed wireframe” approach 100 to enforce equilibrium of the forces acting on the fastener means that the accuracy of the predictions will always be in question.

Thus, a need exists for a more accurate modeling program, and associated method of performing stress analysis of multilayered joints which is compatible with general purpose finite element programs used for structural analysis.

### BRIEF DESCRIPTION OF THE INVENTION

In a first aspect, the invention is a method of modeling a fastener in a computer-based finite element model of an multi-layer lap shear joint. The joint finite element model has a system stiffness matrix formed by summing up the individual stiffness matrices of the elements comprising the model. The invention, by allowing the generation of a stiffness matrix for the fastener which is compatible with the stiffness matrices of the adjacent elements, enables the fastener to join a plurality of components into an assembly at the joint. Compatibility is maintained by reducing the continuous displacements and support reactions for the beam-on-elastic foundation model of the fastener into a system of generalized forces and displacements, i.e., a system of non-uniform forces and displacements reduced to equivalent point forces and displacements. The method allows determination of stresses and strains existing in the fastener and in the plurality of components at the joint using a general purpose finite element analysis program. The method maintains compatibility with general purpose finite element programs by idealizing the fastener as a multi-noded line element, with each node serving as a connection point to a layer. To incorporate the special fastener line element into a general purpose program, the coefficients of the stiffness matrix for the element are calculated based upon the number of layers in the joints, the thicknesses and elastic properties of the layers, and the geometry and the elastic properties of the fastener. These coefficients can be calculated by a module external to the general purpose finite element program. Once the stiffness matrix coefficients have been formatted into a form compatible with the general purpose finite element program, the line element stiffness matrix is incorporated into the system stiffness matrix. Once this has been done for each of the fasteners, the joint finite element model is solved for nodal displacements and forces, including the displacements and forces occurring at the fastener line element nodes. Because the nodal forces and moments acting on the nodes of the virtual fastener line element, along with the nodal displacements, represent generalized forces and displacements, a post-processor routine takes the nodal displacements from the solution of the finite element model, and, using the same beam-on-elastic foundation model of the fastener used to generate the generalized forces and displacements for the stiffness matrix, synthesizes the continuous through-the-thickness distribution of displacements and bearing stresses for each layer of the fastener.

The coefficients for the stiffness matrix of the virtual fastener line element stiffness matrix can be determined by “work-averaging” the distributed fastener reactions and displacements from the beam-on-elastic foundation idealization of the fastener and replacing them with equivalent point forces and displacements at the connections to the layers. Work averaging can be accomplished by idealizing the fastener/hole interface as a buffer zone surrounding the hole. The buffer zone is a hollow cylindrical volume of material which has the same Young's modulus and Poisson's ratio as the layer and whose inner boundary is the hole and the outer boundary is a hypothetical boundary located an infinitesimal distance away from the hole. For a fastener penetrating a multi-layer stack-up, a buffer zone exists for each of the layers penetrated to couple the fastener to the layer. It is this buffer zone concept which is central to the virtual fastener line element. The buffer zone serves to absorb the deformation of the fastener and to redistribute the reactions arising from the non-linear deformations into a boundary region where the forces and displacements are linear through the thickness of each layer. Because the forces and displacements at the outer boundary of the buffer zone are linear, they are compatible with the forces and displacements of the wireframe elements comprising the layer. The buffer zone concept allows the beam-on-elastic foundation model of the fastener to consist of the beam segments representing the portion of the fastener passing through each layer, the elastic foundation springs representing the buffer zone, and rigid supports for the springs, i.e., the outer boundary of the buffer zone. These rigid supports are capable of undergoing translational or rotational displacements in response to point translational or rotational forces and displacements arising from the connection to the elements comprising the layers. Because of the buffer zone, the terms of the stiffness matrix for the virtual fastener line element can be generated by applying a unit translation or rotation to a support segment, while the other support segments of the fastener remain clamped. This is a well-known finite element method approach used for numerically generating the stiffness matrix terms for elements from the nodal displacements (see, for example, Elementary Matrix analysis of Structures, Hayrettin Kardenstuncer, McGraw-Hill, Chapter 9, which is incorporated herein by reference in its entirety, and in particular see page 338); it can be applied to the virtual fastener line element because of the buffer zone concept. The force or moment required to produce the translation or rotational (as determined by work-averaging the continuous foundation reactions and displacements) represents the direct stiffness term for the degree-of-freedom, i.e., displacement component, while the reactions represent the cross-coupling stiffness terms. This process is repeated for all nodes to generate the virtual fastener stiffness matrix.

In a second aspect, the invention is a computer program product or module for use with a conventional finite element analysis program for structural analysis of a joint having a plurality of components joined by a fastener. The computer program product comprises a first executable portion capable of receiving information regarding the fastener and the plurality of components, a second executable portion capable of automatically generating a stiffness matrix representative of the fastener, and a third executable portion capable of transforming the nodal displacements from the general purpose finite element program into a detailed distribution of the bearing stresses acting on the shank of the fastener, the deformed shape of the fastener, and the stress field surrounding the hole. Together, the three modules provide the pre and post-processing capability needed to incorporate virtual fastener line elements into the input file of a general purpose finite element program, and to post-process the output from the program into the through-the-thickness distributions of the stresses acting on the fastener and the displacements of the fastener. A key capability of the computer program is that it contains algorithms for subjecting each of the rigid support segments of the foundation springs to an unit translation or rotation. This is a unique capability in that all known solutions for a beam-on-elastic foundation deal only with the application or displacement or forces to the beam, and not to the underlying foundation supporting the springs. Another capability of the modules is that the step of calculating coefficients of the line element stiffness matrix is accomplished using a transfer matrix approach based on a model of the fastener as a beam supported by continuous elastic springs along the shank and by elastic rotational supports located at opposing ends of the beam. The rotational springs represent the restraint against overturning of the fastener provided by the head and the collar of the fastener. The use of the transfer matrix enables the quick generation of the stiffness matrix terms for a multi-layer fastener, thus making it practical to implement the virtual fasteners in a general purpose finite element computer program. Using this transfer matrix approach, the step of calculating the coefficients includes a first sub-step of calculating distributed forces and moments resulting from unit displacements imposed on each elastic spring support segment of the beam-on-elastic foundation model of the fastener, with the assumption that the remaining spring support segments are fixed, and a second sub-step of work-averaging the distributed forces and moments into generalized forces at the mid-thicknesses of each layer by integrating the forces over the layer thickness and dividing by the layer thickness.

### BRIEF DESCRIPTION OF THE SEVERAL VIEWS OF THE DRAWINGS

For the purpose of illustrating the invention, there are shown in the drawings forms of the invention which are presently preferred; it being understood, however, that this invention is not limited to the precise arrangements and instrumentalities shown. In the drawings:

FIG. 1 is a partial cross-sectional side view of a conventional overlapping joint having multiple layers secured by a fastener.

FIG. 2 is a representation of a prior art wireframe finite element model of the overlapping joint and fastener of FIG. 1.

FIG. 3 is a representation of a prior art conventional volumetric finite element model of the overlapping joint and fastener of FIG. 1.

FIG. 4A is a partial cross-section of a two-layer bolted joint capable of being analyzed using a beam-on-elastic foundation analytical model.

FIG. 4B is a representation of a prior art beam-on-elastic foundation analytical model applied to the bolted joint of FIG. 4A.

FIG. 4C is a representation of a prior art wireframe finite element model based upon the beam-on-elastic foundation analytical model of FIG. 4B.

FIG. 4D is a representation of a prior art collapsed wireframe finite element model of the bolted joint of FIG. 4A.

FIG. 5A is a representation of a prior art beam-on-elastic foundation analytical model of a fastener in a two-layer joint.

FIG. 5B is a representation of a prior art series and parallel spring analytical model of the fastener of FIG. 5A.

FIG. 5C is a representation of the prior art series and parallel spring analytical model of FIG. 5B applied to a plurality of fasteners.

FIG. 6A is a representation of a wireframe finite element model having a line element representation of the fastener of FIG. 1, in accordance with a preferred embodiment of the present invention.

FIG. 6B is a representation of the line element of the model of FIG. 6A, showing concentrated forces and moments applied at mid-layer node points.

FIG. 7A is a representation of a beam-on-elastic foundation model of a fastener joining a plurality of layers, wherein a unit translational displacement is imposed on a single layer while the remaining layers are assumed fixed.

FIG. 7B is a representation of the beam-on-elastic foundation model of FIG. 7A, wherein a unit rotational displacement is imposed on a single layer while the remaining layers are assumed fixed.

FIG. 7C is an enlarged view of a head portion of a fastener, having a rotational stiffness relating an angular displacement of the head and the moment required to generate that angular displacement.

FIG. 7D is a representative plot of the relationship between angular displacement and moment for the fastener head of FIG. 7C.

FIG. 7E is representation of the fastener model of FIGS. 7A and 7B, modified in accordance with the present invention to incorporate an elastic boundary region, allowing non-linear deflections of the fastener shank.

FIG. 7F is a partially schematic representation of the fastener of FIG. 7E with elastic boundary regions between the shank and the plurality of layers.

FIG. 8A is a representation of the line element of FIG. 6B, showing unit translations and rotations applied at mid-layer node points.

FIG. 8B is a representation of the line element of FIGS. 6B and 8A, showing concentrated forces and moments corresponding to the unit translations and rotations and applied at the mid-layer node points.

FIG. 8C is a generalized stiffness matrix for relating forces and moments to translational and rotational displacements of the line element of FIGS. 6B, 8A and 8B.

FIG. 9 is a flow diagram illustrating a method of modeling a fastener in accordance with the present invention.

FIG. 10A is a side view of a clevis lug joint analyzed as a numerical example of application of the techniques of the present invention.

FIG. 10B is a top plan view of the clevis lug joint of FIG. 10A.

FIG. 10C is a graphical representation of a wireframe finite element model of the clevis lug joint of FIGS. 10A and 10B.

FIG. 10D is a stiffness matrix calculated using the techniques of the present invention and associated with a line element corresponding to a fastener of the clevis lug joint of FIGS. 10A and 10B.

FIG. 10E is a table showing nodal displacements of nodes of the wireframe finite element model of FIG. 10C calculated using the analytical techniques of the present invention.

FIG. 10F is a freebody diagram of forces and moments acting upon elements of the wireframe finite element model of FIG. 10C.

FIG. 10G is a plot of the deflected shape of the fastener of FIGS. 10A and 10B calculated using the analytical techniques of the present invention.

FIG. 10H is a plot of bearing stresses imposed on the fastener of FIGS. 10A and 10B calculated using the analytical techniques of the present invention.

FIG. 11 is a flow diagram illustrating a computer program product for implementing the method of modeling a fastener of FIG. 9.

### DETAILED DESCRIPTION OF THE DRAWINGS

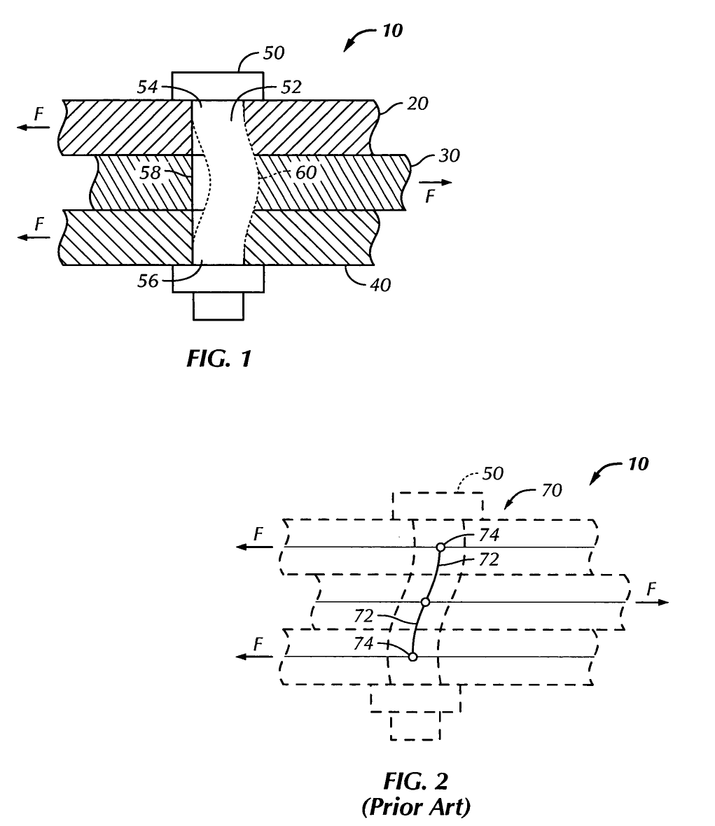

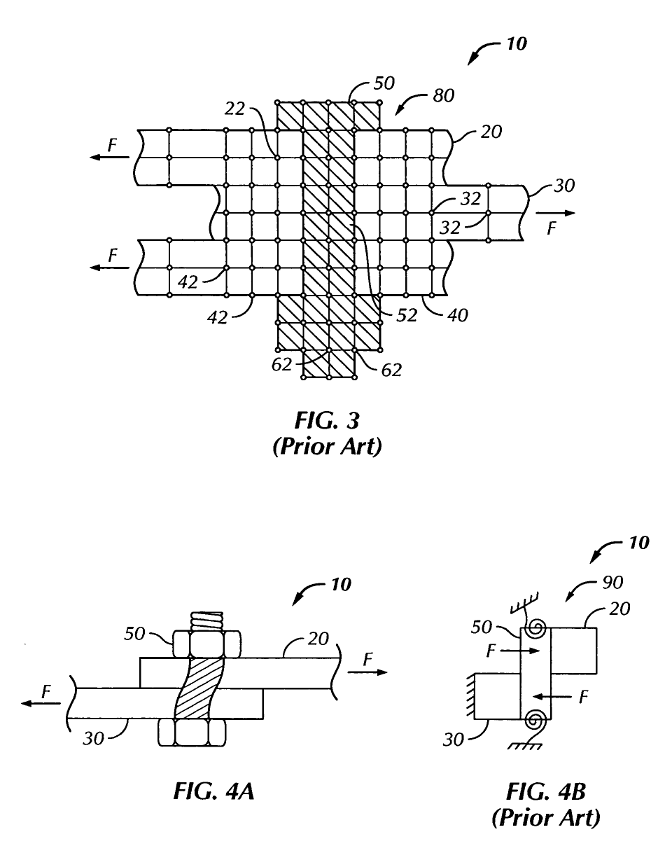

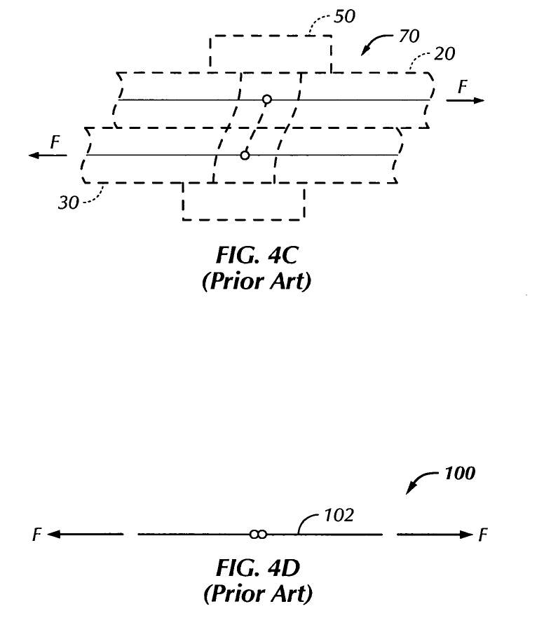

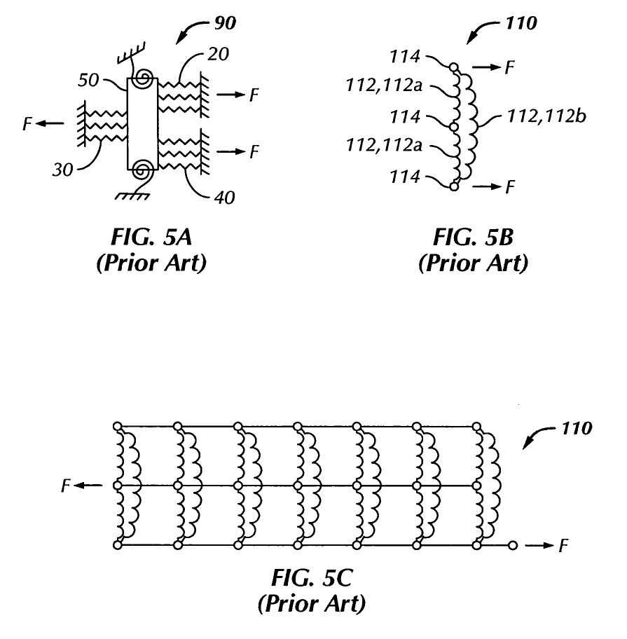

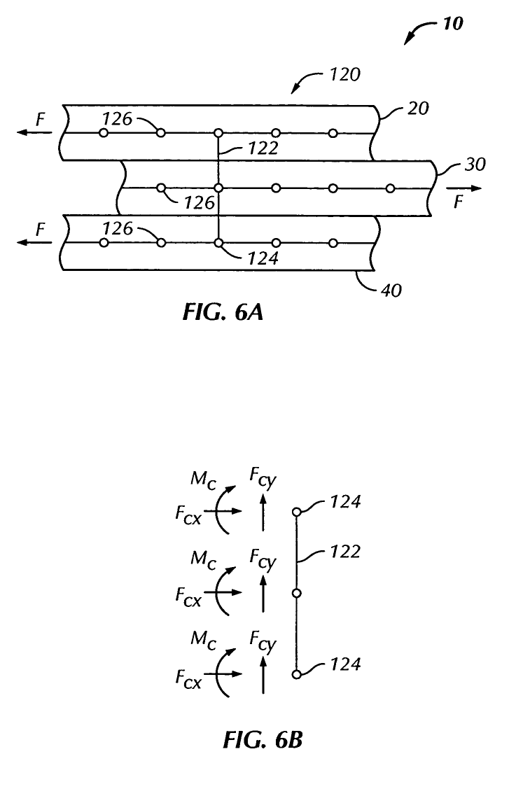

Referring to the drawings, and initially to FIGS. 1 and 6A, a beam (or plate/shell) finite element model 120 of a multi-layered joint 10 without the holes explicitly included in the model mesh comprises a plurality of components or layers 20, 30, and 40 and incorporates a line element 122 representation of a fastener 50. The finite element model 120 includes a system stiffness matrix (not illustrated). The line element 122 comprises a plurality of nodes 124, with at least one node corresponding to each of first through third components 20, 30 and 40. The first through third components 20, 30, and 40 are modeled by a plurality of wireframe elements having a plurality of nodes 126.

With reference to FIG. 6B, the present invention operates by replacing distributed bearing pressures and displacements of a conventional beam-on-elastic foundation model 90 of the fastener 50 with generalized concentrated forces F_{c}, moments M_{c} and displacements which act on a virtual fastener line element 122 at the mid-thickness of each layer.

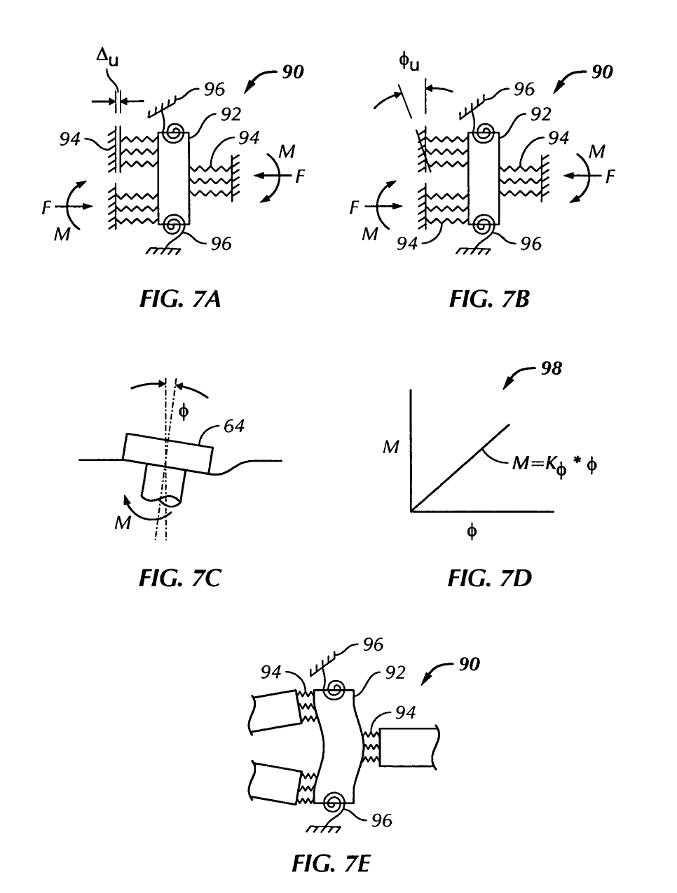

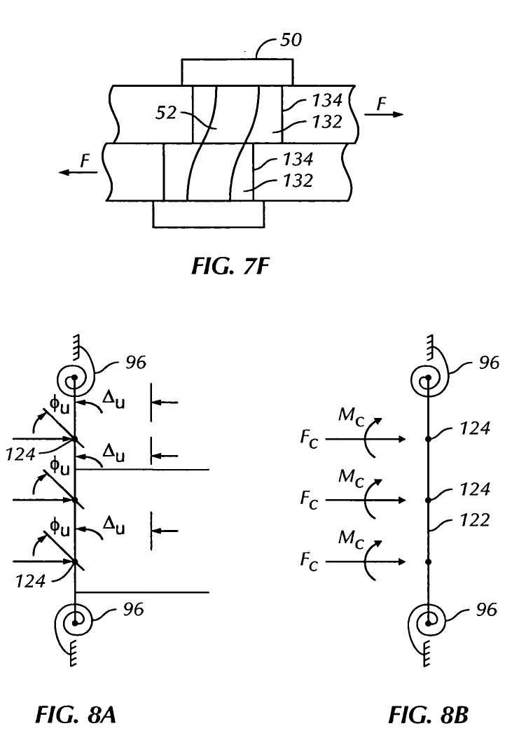

With reference now to FIGS. 7A and 7B, the beam-on-elastic foundation model 90 of a fastener consists of beam segments 92 which are supported by a continuous elastic foundation 94. The assemblage of beam segments 92 is restrained at opposing ends by rotational springs 96. Rotation of the springs 96 is directly proportional to the applied moment via the inverse of a head/collar rotation stiffness K_{φ}. With reference to FIGS. 7C and 7D, the rotational springs 96 allow the beam-on-elastic foundation model 90 to incorporate the restraining effects of the fastener head 64 and collar, both of which help react the overturning moment M on the fastener 50, resulting in an angular displacement φ. The specified proportionality between the moment and rotation at the fastener head or collar is given, as indicated by plot 98 (see FIG. 7D), by M=K_{φ}φ, where M is the moment, K_{φ} is the rotational stiffness of the fastener head 64 or collar, and φ is the nodal rotation. Values of K_{φ} may be determined experimentally, or analytically, from a detailed solid finite element model of the fastener 50.

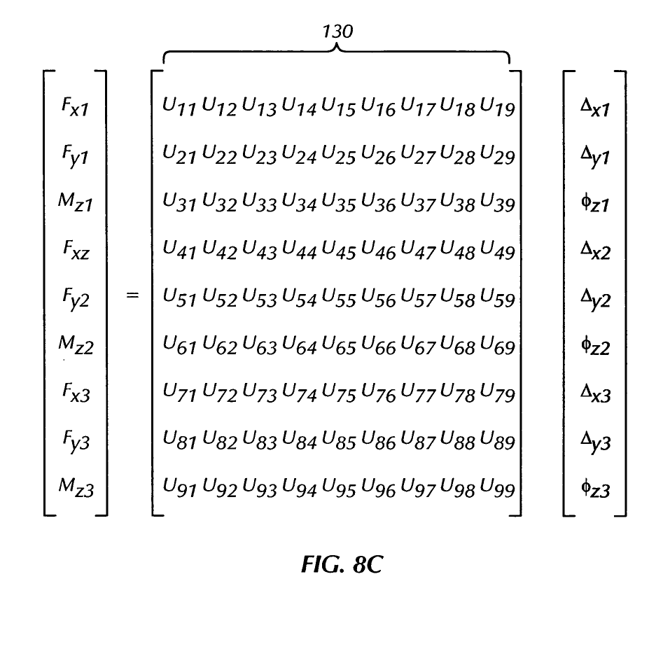

With reference to FIGS. 7A and 8A-8C, in order to generate the translational terms for a fastener stiffness matrix 130, a unit translational displacement Δᵤ is imposed upon the support of the elastic foundation 94 of a particular layer, while keeping the remaining support segments fixed. This support corresponds to an outer boundary 134 of a buffer zone 132 of the fastener 50 (see FIG. 7F). The distributed reactions are integrated for both the displaced segment and the fixed segments to find the equivalent generalized force F_{c} and moment M_{c} required to produce the unit displacement and the reactions induced by the translation Δᵤ.

Referring now to FIGS. 7B and 8A-8C, the rotational terms of a fastener stiffness matrix 130 are generated in a similar manner by subjecting the support for the elastic foundation of a layer to a unit rotational displacement φᵤ, and then integrating the distributed reactions for both the displaced support segments and for the fixed segments to find the equivalent generalized force and moment reactions induced by the rotation. The translational and rotational displacements of the elastic foundation for each layer simulate the rigid body translations and rotations of the layers due to the elastic deformation of the fastener.

By successively applying unit translations and rotations to each of the layers, while keeping the remaining layers fixed, the diagonal and off-diagonal terms of the stiffness matrix 130 (see FIG. 8C) relating the nodal translational and rotational displacements to the nodal generalized forces F_{c} and moments M_{c} are generated for the fastener line element. This stiffness matrix 130 is symmetric, as each unit translation or rotation solution results in a set of self-equilibrating forces and moments at each of the line element nodes 124. Consequently, the fastener line element 122 will always be in equilibrium for any combinations of nodal displacements and rotations. The result permits the fastener 50 to be more accurately modeled in an existing finite element program by incorporating the fastener 50 as a special bar element with a user defined stiffness matrix.

Referring now to FIGS. 6B, 7E, and 7F, in the present invention, the elastic foundation 94 acts as a boundary buffer zone region 132, coupling the fastener to the plate element (the layer). Under Kirkhoff beam theory, which is used to generate the stiffness matrices for the beam or plate/shell elements representing the layers, a hole must remain perpendicular to the surface of the plate. However, the deflected shape of a fastener under load is generally non-linear. In the present invention, the elastic foundation 94 is analyzed as a “soft” boundary region, i.e., buffer zone 132, surrounding the hole that elastically couples the fastener to the hole boundary 134. Because the elastic foundation 94 is soft it can absorb the non-linear deflections of the fastener shank, while at the same time maintaining compatibility with the hole (i.e., maintaining perpendicularity of the hole to the surface of the plate or shell element.) FIG. 6B represents the resulting line element 92 for a fastener 50 penetrating three-layers, using the present invention. Similar representations can be generated for fasteners penetrating other than three-layers, with the number of nodes of the line element 92 equal to the number of layers penetrated.

By generating a stiffness matrix 130 (see FIG. 8C) which relates the nodal displacements and translations to the nodal forces, the present invention allows for use of a simple line element in any finite element analysis program, such as a MSC.Nastran program sold by MSC Software Corporation, Santa Ana, Calif., or in a stand-alone finite element analysis program.

Interoperability with a general purpose finite element program is maintained by generating the fastener line element stiffness matrix 130 in a form which is compatible with the program. In a general purpose finite element programs, the stiffness matrix K relates the nodal displacements to the nodal forces by the following equation:
[p]=[K][d] Equation 1
where p is the column matrix of the forces and moments acting on the node, K is the system stiffness matrix, and d is the column matrix of the displacements and rotations. The system matrix is formed by superposition of the individual element stiffness matrix. Once the system matrix has been formed by assembly of the stiffness matrices of each of the elements in the finite element model, the nodal displacements can be obtained by inversion of the matrix. In order for the fastener line element stiffness matrix to be compatible with general purpose finite element programs, the element stiffness matrix likewise must be of the same form as Eq. (1). In the present invention, the fastener element stiffness matrix U 130 relates the nodal displacements to the nodal forces by the following equation:
[p]=[U][d] Eq. [2]
where p is the column matrix of the forces and moments acting on the node, U is the fastener line element stiffness matrix 130, and d is the column matrix of the displacements and rotations.

To form the element stiffness matrix U, the generalized forces and displacements are replaced with the concentrated forces and moments, F_{c}, M_{c}, and the concentrated displacements and rotations, Δ_{c}, φ_{c}, that are obtained using the beam-on-elastic foundation analysis 90 described above (i.e., the point loads applied at the center of the layer). After the stiffness matrix is calculated for the fastener, it is assembled into the system stiffness matrix in the finite element analysis that is associated with the joint.

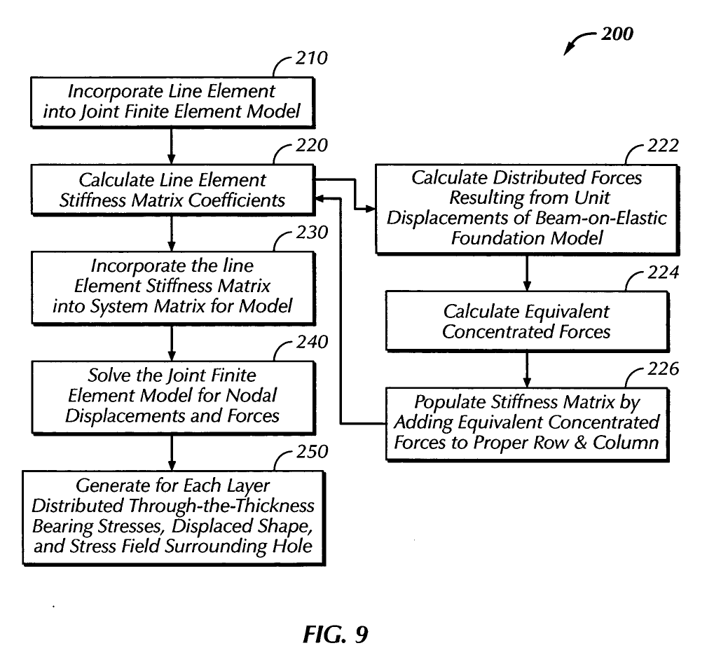

Referring now to FIG. 9, a method 200 of modeling the fastener 50 in a computer-based finite element model 120 of an overlapping joint 10 is illustrated in flow diagram form. The method 200 allows determination of stresses and strains existing in the fastener 50 and in the plurality of components or layers 20, 30, and 40 at the joint 10. The method 200 comprises a first step 210 of incorporating into the finite element model 120 a line element 122 representing the fastener 50. In a second step 220, coefficients of the line element stiffness matrix 130 are calculated based on known boundary conditions. In a third step 230, the line element stiffness matrix 130 is incorporated into the system stiffness matrix for the joint. In a fourth step 240, the joint finite element model is solved for nodal displacements and forces, including the displacements and forces occurring at the fastener line element nodes 124. In a fifth step 250, the distributed through-the-thickness variation in the bearing stresses, the fastener displaced shape, and the stress field surrounding the hole is generated for each layer from the nodal displacements.

With reference now to FIGS. 8A-8C and 9, the second step 220 of calculating the coefficients includes a first sub-step 222 of calculating distributed forces and moments resulting from unit displacements (both translational unit displacements Δᵤ and rotational unit displacements φᵤ). As discussed above, this is achieved by sequentially imposing on each line element node 124 the unit displacements Δᵤ with the assumption that the remaining nodes 94 are fixed. Applying the specified displacements along with the boundary conditions of zero shear and a specified proportionality between the moments and rotation at the ends of the assemblage of beams comprising the fastener shank 52, it is possible to calculate from the beam-on-elastic foundation model 90 of the fastener the distributed forces and moments resulting from the unit displacements Δᵤ and φᵤ.

One method for generating the line element stiffness matrix 130 is through use of a transfer matrix approach based on a model of the fastener 50 as a beam supported on an elastic foundation as described above. The transfer matrix approach is well known for generating displacements and forces on a beam, and is described in W. D. Pilkey and P. Y. Chang, Modern Formulas for Static and Dynamics, McGraw Hill, pages 53-54 (1978), which is incorporated herein by reference in its entirety. This analysis tool is used in the present invention to determine the affect of the unit displacements.

For the example of the lap joint shown in FIG. 6A, Equation 1 is solved by first forming the fastener line element stiffness matrix U for each element, and adding the terms of U into the system matrix K of equation 1. For a general 2D finite element model, the fastener stiffness matrix 130 is a symmetric 3 m×3 m matrix where m is the number of logical nodes in the fastener line element. The logical node number refers to the relative node number within the line element, and may differ from the identification numbers assigned to the nodes by the finite element program, since, in the finite element model of the joint, node numbers are assigned in the sequence in which they are declared in the input file. The line element stiffness matrix 130 relates the horizontal and vertical translation displacements and the rotation displacement of the node to the horizontal and vertical forces, and the rotational moment, as shown by the matrix relationship in FIG. 8C, for the 3 noded line element of FIG. 6A. This is the standard way in which an element stiffness matrix is represented in a finite element program, thus allowing the assembly of the element stiffness matrix into the system matrix K of eq [1] using standard assembly procedures outlined in textbooks such as Concepts and Applications of Finite element Analysis, R. D. Cook, Wiley and Sons, 1974, which is incorporated herein by reference in its entirety (in particular, see pages 31-32). Each of the Uᵢⱼ terms of the element stiffness matrix 130 is generated from the beam-on-elastic foundation model 90 of the fastener by applying a unit displacement or rotation to a elastic spring support segment, restraining the other support segments to have zero displacements, determining the distributed reactions along the support segments, and converting the distributed reactions to generalized quantities by integrating the distributed reactions along the thickness of each layer and dividing by the thickness. As this process is repeated for each node 124, the reactions are added to the line element stiffness matrix 130. As an example, the term U₁₁ in the stiffness matrix of FIG. 8C is formed by adding 9 separate reactions: the first term is the force required to cause a unit horizontal displacement of logical node 1, the second term is the horizontal reaction at logical node 1 when it is subjected to an unit vertical displacement, the third term is the horizontal reaction at node 1 when it is subjected to a unit rotation, and the 6 remaining terms of U are the horizontal reactions at node 1 when the remaining 6 degrees-of-freedom are subjected to an unit displacement (or rotation). By repeating this process for each of the degrees-of-freedom at a node, the stiffness matrix 130 for the fastener can be fully populated.

In a second sub-step 224, concentrated unit forces F_{c} and moments M_{c} applied at each node 124 are calculated from the distributed reactions by numerical integration. That is, the concentrated force reaction F_{c} may be found from F_{c}=∫f(u)du where f(u) is the distributed reaction along a elastic spring support segment, u is the distance from the layer surface to the integration point, and the integration is performing with u varying from 0 to the layer thickness T. Likewise, the concentrated moment reaction M_{c} may be found from M_{c}=∫(0.T*t−u)*f(u)du where f(u) is the distributed reaction (as determined from the elastic foundation spring forces) along a layer, u is the distance from the layer surface to the integration point, and the integration is performed with u varying from 0 to the layer thickness T. For both forces and moments, the concentrated force or moment may be determined by evaluating the equations using known numerical integration techniques, i.e., trapezoidal rule for numerical integration, or Simpson's Rule for numerical integration. If applied at the nodes 124, each unit force F_{c} and moment M_{c} has a magnitude resulting in equivalent virtual work, i.e., the work done by the concentrated force in undergoing the concentrated displacement is equal to the total work done by the distributed forces in undergoing the displacements along the segment of the line element 122, as the corresponding distributed force and moment. This equivalency of the work done by the concentrated forces and the distributed forces assures, via the energy principles of structural mechanics (see, Elementary Matrix Analysis of Structures, Hayrettin Kardenstuncer, McGraw-Hill, Chapter 5, which is incorporated herein by reference in its entirety), that the element stiffness matrix is symmetrical, and produces, for any set of nodal displacements, nodal forces which are in static equilibrium.

In a third sub-step 226, the stiffness matrix coefficients are calculated by adding the concentrated unit forces and moment together at each node so that each stiffness matrix term represents the sum of the forces and moments arising from the each of the displacements.

The results of this calculation are the line element stiffness matrix coefficients shown in step 220 of FIG. 9. As discussed above, the line element stiffness matrix coefficients from this step are then incorporated into the system stiffness matrix used in the finite element analysis (step 230). Once the fastener line element stiffness matrices have been added to the system stiffness matrices, the system stiffness matrix may be inverted to find the nodal displacement components. From the nodal displacements, the forces acting on each element may be obtained by multiplying the nodal displacements for the element by its stiffness matrix.

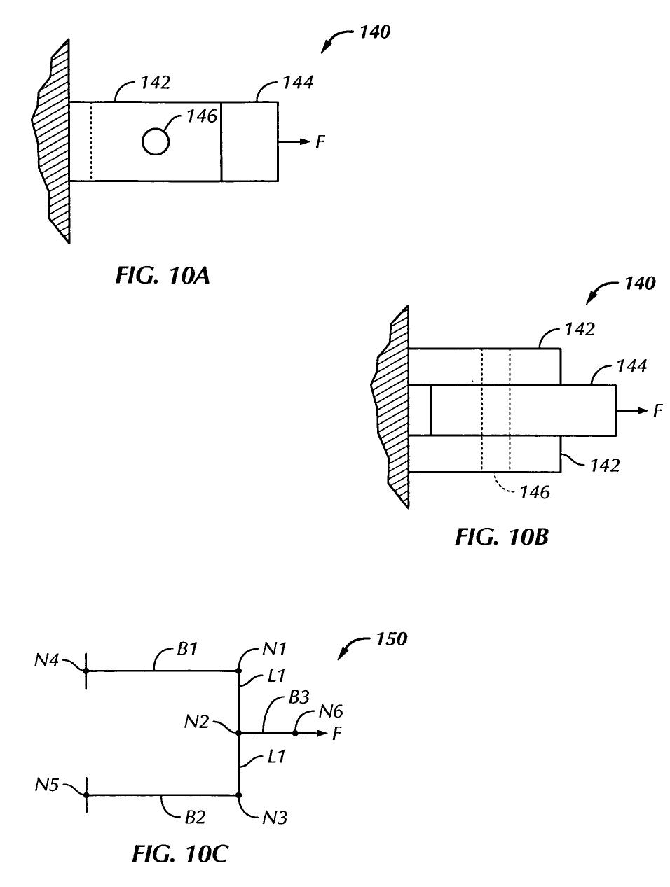

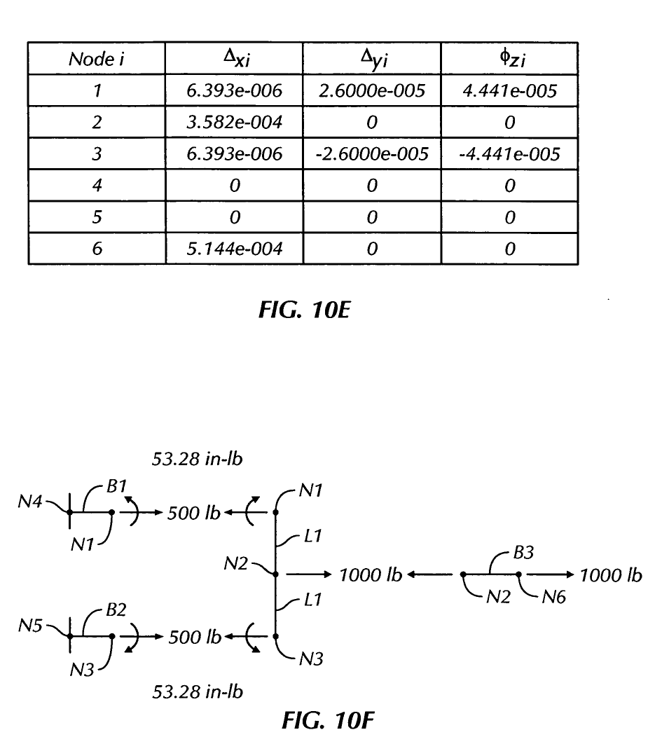

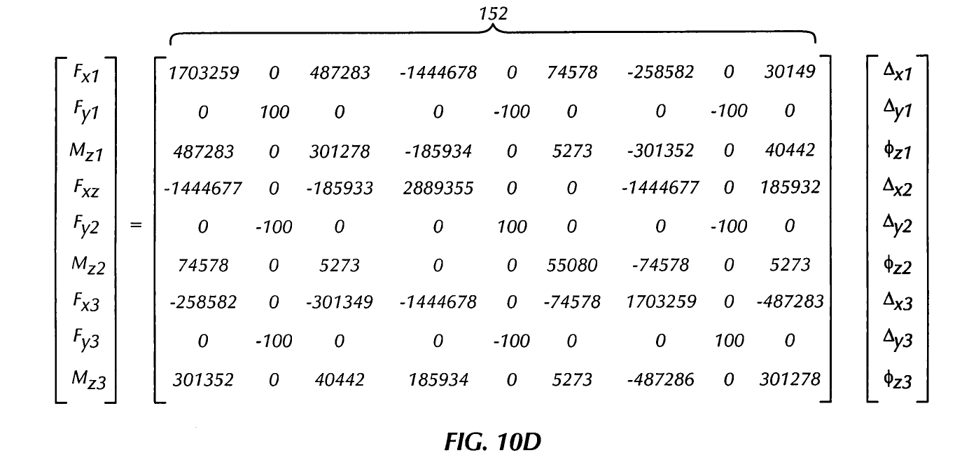

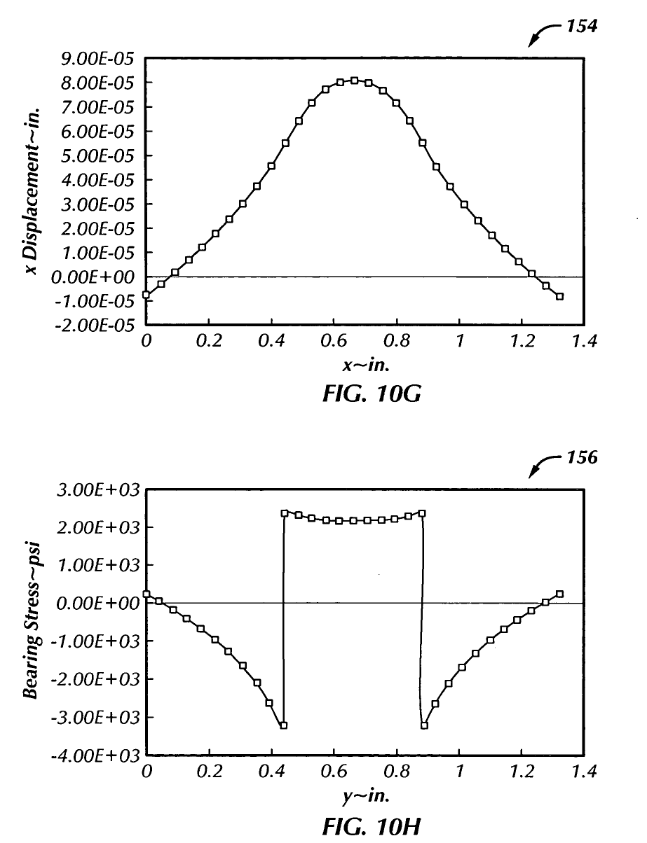

A numerical example of application of this technique to a multi-layer joint is illustrated in FIGS. 10A-10H. With reference to FIGS. 10A and 10B, a clevis lug joint 140 comprises outer female lugs 142 and an inner male lug 144. For purposes of this numerical example, the outer lugs 142 and inner lug 144 are assumed to be fabricated from 0.44 inch thick by 2.00 inch wide aluminum plate. A 0.625 inch diameter steel pin 146 connects the male lug 144 to the outer female lugs 142. With reference to FIG. 10C, the clevis leg joint 140 can be idealized by a wireframe finite element model 150 consisting of 6 nodes, N1-N6, 3 bar elements, B1-B3, and one 3 node virtual fastener line element, L1. The bar elements, B1 and B2, representing the outer female lugs are rigidly restrained, while an axial load of 1000 pounds is applied to the end of bar element B3. FIG. 10D shows the stiffness matrix 152 generated for the fastener line element L1 by modeling the fastener as a three-segment beam on an elastic foundation. FIG. 10E shows a tabulation of the nodal displacements determined by incorporating the fastener stiffness matrix 152 into the system stiffness matrix for the 2-dimensional finite element model of the joint and by solving the system equation for the nodal displacement components. Once the nodal displacements are known, the information needed for a detailed stress analysis of the fastener and the layers may be generated from the beam-on-elastic foundation model of the fastener. With reference to FIG. 10F, a freebody diagram of the bar and line elements B1-B3 and L1 was obtained by multiplying the nodal displacements for each element by its stiffness matrix generated from the beam-on-elastic foundation model of the fastener. With reference to FIG. 10G, a plot 154 of the displaced shape of the fastener 50 was generated by applying the nodal displacements at the fastener element nodes N1-N6 as specified displacements of the elastic spring support segments of the beam-on-elastic foundation model of the fastener. With reference to FIG. 10H, a plot 156 of bearing stresses in the fastener 50 was generated by applying the nodal displacements as specified displacements of the elastic spring support segments of the beam-on-elastic foundation model of the fastener.

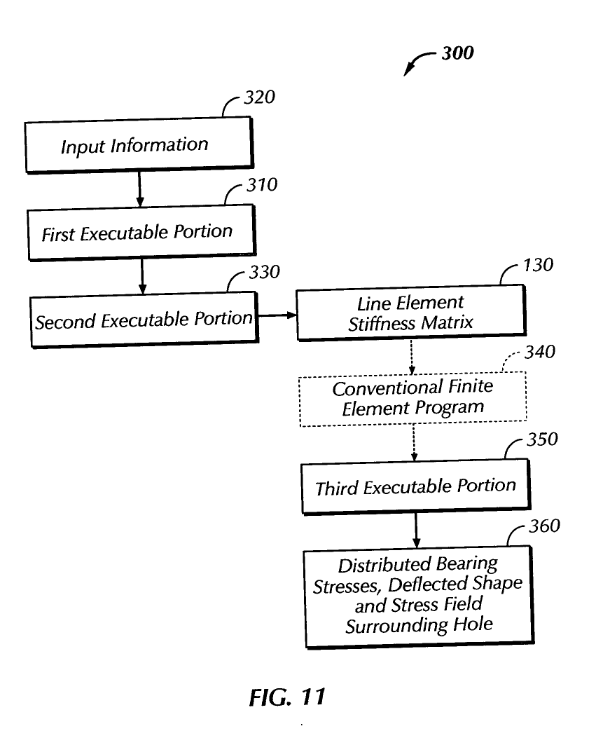

With reference now to FIG. 11, in a further aspect, the invention relates to a computer program product 300 for use with or in a finite element analysis program, such as an MSC.Nastran program, for structural analysis of a joint 10 having a plurality of components or layers 20, 30, 40 joined by a fastener 50. The computer program product 300 comprises a first executable portion 310 capable of receiving input information 320 regarding the fastener and the plurality of layers, a second executable portion 330 capable of automatically generating the stiffness matrix 130 representative of the fastener 50, and a third executable portion 350 capable of generating for each layer the distributed through-the-thickness variation of the bearing stress, the fastener displaced shape, and the stress field surrounding the hole from the nodal displacements determined by the general purpose finite element program. These executables are preferably part of a program that is stored in a medium, such as a CD-ROM, hard drive, removable or fixed memory device, programmed EPROM, or other known medium storage devices. Preferably the storage medium is encoded with machine-readable computer program code which directs a computer to perform the steps outlined above and illustrated in the accompanying figures. The stiffness matrix 130 generated by the program is suitable for use by the finite element analysis program 340 in analysis of the joint 10. The fastener 50 is modeled as a line element 122 in the finite element analysis program 340, using a beam-on-elastic foundation model of the fastener 50.

The computer program product 300 may be supplied as a stand-alone software package by integrating it with a suitable finite element program or alternatively may be used with a standalone preprocesser and postprocessor for a general purpose finite element program. For example, it is contemplated that the product 300 may be a software program that operates independently of the finite element program. After the design of interest is modeled in the finite element program, the fasteners can be added to the model by using the computer program product 300 as a preprocessor program to generate the stiffness matrices for the fasteners in a format which is compatible with the input of the general purpose computer program 340. The finite element model can then be solved using the finite element program to determine the resulting nodal displacements and the loads on the design, including the fasteners. The software program product 300 may then be used to read in the output from the general purpose finite element program, and generate for each layer of a fastener the distributed through-the-thickness variation of the bearing stresses, the displaced shape of the fastener, and the stress field surrounding the hole.

Alternatively, the product may be a computer module (e.g., software subroutine) that operates in conjunction with the finite element program. Thus, when a fastener location is being modeled, the module is activated (selected) and the calculations are automatically performed by the computer to determine the stiffness matrix for the fastener line element and to add it to the finite element program input file in the required format. Upon execution of the finite element program to solve for the unknown displacements, the stiffness matrices for the fastener line elements are added to the system stiffness matrix for subsequent load analysis. Once the system of equations has been solved for the unknown nodal displacements, the computer software product 300 will generate for each layer of a fastener the distributed through-the-thickness variation of the bearing stresses, the displaced shape of the fastener, and the stress field surrounding the hole.

From this disclosure, the artisan will recognize that various calculation techniques may be employed to determine the coefficients of the line element stiffness matrix 130 using the buffer zone concept of FIGS. 7E and 7F to reduce distributed forces and displacements to equivalent point forces and displacements. In general, known numerical techniques could be used to solve the differential equations describing the beam-on-elastic foundation model of the fastener 50 once the fastener has been reduced to such a model using the buffer zone concept of FIGS. 7E and 7F. For example, it would be possible to generate a separate finite element model of the beam-on-elastic foundation model of the fastener 50 by replacing the continuous elastic foundation with a discrete system of springs for each layer, impose unit displacements on the support nodes for the springs, and determine the stiffness matrix coefficients from the resulting discretized forces and moments by summing up the quantities and dividing by the layer thickness. The same model could then be used, once the nodal displacements have been found by the finite element program, to generate the distribution of bearing stress and the displaced shape for each layer by rerunning the model with the displacements applied as the known boundary conditions. Preferably, the second executable portion 330 of the computer program product 300 uses the semi-closed form transfer matrix approach as outlined above (first through third sub-steps 222 through 226) to calculate coefficients of the stiffness matrix; and the third executable portion 350 of the computer program product 300 also uses the semi-closed form transfer matrix approach, to generate the distribution of bearing stress and the displaced shape for each layer. The semi-closed form transfer matrix calculation technique is especially desirable in view of its efficiency.

Preferably, the information 320 received regarding the fastener and components includes the number of the components and geometry (e.g., thickness) of each component layer, layer material properties including Young's modulus and Poisson's ratio, fastener material properties including Young's modulus and Poisson's ratio; the rotational stiffness of the fastener head and collar, and moment of inertia characteristics of the fastener.

The method 200 and associated computer program product 300 thus permit a plurality of fasteners 50 to be readily and accurately modeled in a finite element model containing many such fasteners 50. The computer program product 300 is capable of operating in conjunction with conventional commercially-available finite element programs to efficiently implement the method 200.

The present invention provides finite element modeling of the mechanical behavior of a fastener using coarse finite element meshes. It eliminates the need to model each hole in a joint as a fine detailed mesh surrounding the hole, while allowing the detailed distribution of stresses surrounding the hole to be synthesized. The present invention overcomes the deficiencies associated with existing virtual fastener techniques by imparting a capability to react moments at the nodes, thus assuring equilibrium of the fastener. Furthermore, the present invention can be used as a multi-node bar, i.e., line, element, instead of an assembly of three-dimensional solid elements. The reduction to a bar element representation of the fastener vastly simplifies the task of constructing a finite element model of a multi-layer joint by eliminating the need to model the non-linear bearing contact between the fastener shank and the hole wall. The present invention has particular use in large scale fatigue analyses of multi-layer 3D joints typical of use in aerostructure.

While the invention has been described and illustrated with respect to the exemplary embodiments thereof, it should be understood by those skilled in the art that the foregoing and various other changes, omissions and additions may be made therein and thereto, without parting from the spirit and scope of the present invention.

What is claimed is:

1. A method of modeling a fastener in a computer-based finite element model of a mechanically fastened joint having a plurality of layers, each layer including a hole, and the plurality of layers being joined by the fastener extending through the holes, the finite element model including a nodal mesh which does not explicitly include the holes and further including a system stiffness matrix, the method allowing determination of stresses and strains existing in the fastener and in the plurality of layers at the joint, the method comprising the steps of:
incorporating into the finite element model a line element representing the fastener, the line element having a plurality of nodes, with one node corresponding to each layer;
calculating coefficients of a line element stiffness matrix based on properties of the fastener and characteristics of interaction between the fastener with the layers;
incorporating the line element stiffness matrix into the system stiffness matrix; and
solving the joint finite element model for nodal displacements and forces, including the displacements and forces occurring at the fastener line element nodes.

2. A method of modeling a fastener according to claim 1 further comprising the step of calculating distributed through-the-thickness variation of bearing stresses and a stress field surrounding the hole of each layer based upon the nodal displacement and forces for each layer.

3. A method of modeling a fastener according to claim 1 wherein the step of calculating coefficients of the line element stiffness matrix comprises the step of calculating distributed forces and moments resulting from unit displacements at each node.

4. A method of modeling a fastener according to claim 3 wherein the step of calculating the distributed forces and moments comprises the steps of sequentially imposing on each line element node the unit displacements while maintaining the remaining nodes fixed, determining the distributed reactions along the support segments, and converting the distributed reactions to generalized quantities by integrating the distributed reactions along the thickness of each layer and dividing by the thickness.

5. A method of modeling a fastener according to claim 3 wherein the step of calculating coefficients of the line element stiffness matrix comprises the steps of calculating concentrated unit forces and moments applied at each node from the distributed reactions, adding the concentrated unit forces and moment from the each of the displacements together at each node.

6. A method of analyzing a fastener in a computer-based finite element model of a mechanically fastened multi-layer joint having a plurality of layers, each layer including a hole, and the plurality of layers being joined by the fastener extending through the holes, the joint finite element model including a nodal mesh which does not explicitly include the holes and further including a system stiffness matrix, the method allowing determination of stresses and strains existing in the fastener and in the plurality of layers at the joint, the method comprising the steps of:
incorporating into the finite element model a line element representing the fastener, the line element having a plurality of nodes, with one node corresponding to each layer;
calculating coefficients of a line element stiffness matrix for the model, the step of calculating the coefficients including the sub-steps of:
calculating distributed forces and moments resulting from unit displacements imposed on each line element node while maintaining all other nodes of the line element fixed and applying boundary conditions;
calculating concentrated unit forces and moments for each node, each concentrated unit force and moment having a value that corresponds to a work-averaged value of the calculated distributed force and moment for each node; and
calculating the coefficients of the stiffness matrix by superimposing, on a node-by-node basis, the forces and moments required to produce the concentrated unit displacements and rotations and the reactions induced in the other nodes;
incorporating the coefficients of the line element stiffness matrix into the system stiffness matrix;
solving the joint finite element model for nodal displacements and forces at the fastener line element nodes, and
calculating distributed through-the-thickness variation of bearing stresses and a stress field surrounding the hole of each layer based upon the nodal displacement and forces for each layer.

7. A computer program product for use with a conventional finite element analysis program for structural analysis of a joint having a plurality of layers, each layer having a hole and the plurality of layers being joined by a fastener extending through the holes, the computer program product comprising: a first executable portion capable of receiving information regarding the fastener and the plurality of layers; and a second executable portion capable of automatically generating a stiffness matrix representative of the fastener, the stiffness matrix being suitable for use by the finite element analysis program in analysis of the joint, with the fastener being modeled as a line element having a plurality of nodes, with one node corresponding to each layer.

8. The computer program of claim 7, further comprising a third executable portion capable of determining a distributed through-thickness variation of bearing stresses and a stress field surrounding the hole in each layer, and the through-the-thickness variation in the fastener displacements.

9. The computer program of claim 7, wherein the information received regarding the fastener and layers includes:
number of the layers and geometry of each layer;
Young's modulus and Poisson's ratio of each layer;
rotational stiffness characteristics of a head and a collar of the fastener;
fastener material properties including Young's modulus and Poisson's ratio; and
moment of inertia characteristics of the fastener.

10. The computer program of claim 7, wherein the second executable portion uses a transfer matrix approach to calculate terms of the stiffness matrix based on a model of the fastener as a beam supported by elastic supports, wherein the terms are calculated based upon:
distributed forces and moments resulting from unit displacements imposed on each line element node with the assumption that the remaining nodes are fixed and applying known boundary conditions;
concentrated unit forces and moments applied at each node, each unit force and moment having a magnitude resulting in equivalent virtual work as the corresponding distributed force and moment; and
calculation of the stiffness matrix terms by adding the concentrated unit forces and moments together at each node so that each stiffness matrix term represents the sum of the forces and moments arising from the displacements of each of the nodes of the fastener line element.

11. The computer program of claim 10 wherein the third executable portion uses the transfer matrix approach to generate the distributed through-the-thickness variations in the bearing stresses, the fastener displacements, and the stress field surrounding the hole from the nodal displacements at the fastener line element nodes.

12. A storage medium encoded with machine-readable computer program code, the computer program code for directing a computer to perform the steps of:
receiving a line element finite element model of a fastener for a multi-layer joint having a plurality of layers, each layer including a hole, and the plurality of layers being joined by the fastener extending through the holes, the finite element model including a node point for each layer of the multi-layer joint; and
determining coefficients of a line element stiffness matrix for the model, the step of determining the coefficients including the sub-steps of:
calculating distributed forces and moments resulting from unit displacements imposed on each line element node while maintaining remaining nodes of the line element fixed and applying boundary conditions;
calculating concentrated unit forces and moments applied at each node, each unit force and moment having a value that corresponds to the calculated distributed force and moment at a particular node; and
calculating the coefficients of the line element stiffness matrix based on ratios of the concentrated unit forces and moments and the unit displacements.

13. The storage medium of claim 12 further comprising the step of incorporating the coefficients of the line element stiffness matrix into the system stiffness matrix.

14. The storage medium of claim 13 further comprising the steps of solving the joint finite element model for nodal displacements and forces at the fastener line element nodes, and calculating distributed through-the-thickness variations in bearing stresses, fastener displacements, and a stress field surrounding the hole from the nodal displacements at the fastener line element nodes.
